(19) United States
(12) Patent Application Publication
(10) Pub. No.: US 2025/0181710 A1
(43) Pub. Date: Jun. 5, 2025

(54) INFORMATION PROCESSING APPARATUS, INFORMATION PROCESSING METHOD, AND COMPUTER-READABLE RECORDING MEDIUM

(71) Applicant: NEC Corporation, Minato-ku, Tokyo (JP)

(72) Inventor: Shunichi KINOSHITA, Minato-ku, Tokyo (JP)

(73) Assignee: NEC Corporation, Minato-ku, Tokyo (JP)

(21) Appl. No.: 18/842,864

(22) PCT Filed: Mar. 18, 2022
(86) PCT No.: PCT/JP2022/012785

§ 371 Date: Aug. 30, 2024

(51) Int. Cl. G06F 21/55

(52) U.S. Cl. CPC G06F 21/552; G06F 21/554; G06F 2221/034

(57) ABSTRACT

An information processing apparatus includes a case example extraction unit. The case example extraction unit extracts, with the use of an analysis result of a cyberattack that includes an attack route and an attack technique corresponding to the attack route, a case example in which the attack technique corresponding to the attack route appears, from a group of case examples of cyberattacks associated with attack techniques.

### TECHNICAL FIELD

The present disclosure relates to an information processing apparatus and an information processing method for extracting a past cyberattack case example, and in particular relates to a computer-readable recording medium in which a program for realizing the information processing apparatus and the information processing method is recorded.

### BACKGROUND ART

Computer systems are connected to the outside via networks, and are always exposed to threats of cyberattacks from the outside. For this reason, it is important for organizations such as corporations and government offices to ensure the security of their computer systems, and thus risk assessment of the computer systems is required. In a method of risk assessment, a possible attack route in a computer system is specified, and the risk of the attack route is evaluated.

Patent Document 1 discloses an apparatus for performing risk assessment. The apparatus disclosed in Patent Document 1 executes threat analysis of a system based on functional application model information obtained by modelling a functional application of the target system and vulnerability model information obtained by modeling the vulnerability using system specifications.

Incidentally, in risk assessment, it is important to specify a past similar attack case example in which a specified attack route was used, as reference data, but the apparatus disclosed in Patent Document 1 does not have a function of specifying a past attack case example. In contrast, Patent Document 2 discloses an apparatus that specifies a past attack case example.

Specifically, the apparatus disclosed in Patent Document 2 extracts an envisioned attack route in a target system, and also performs determination on an attack usage based on the positions of nodes that make up the attack route. In addition, the apparatus disclosed in Patent Document 1 performs determination on a condition for the nodes (node condition) that make up the attack route based on the types of and the connection relation between apparatuses that constitute the system. The apparatus disclosed in Patent Document 1 then searches for an attack case example in a database that stores data indicating attack case examples, using the determined attack usage and node condition as a search query.

### LIST OF RELATED ART DOCUMENTS

### Patent Document

Patent Document 1: International Patent Publication No. WO 2019-093059
Patent Document 2: Japanese Patent No. 6928265

### SUMMARY OF INVENTION

### Problems to be Solved by the Invention

Incidentally, a search for an attack case example needs to be performed based on not only an attack route, but also an attack technique. This is because attack techniques used in cyberattacks are becoming more complicated year after year. However, the apparatus disclosed in Patent Document 2 is not capable of searching for an attack case example based on an attack technique, and it is difficult to execute such a search.

An example object of the present disclosure is to provide an information processing apparatus, an information processing method, and a computer-readable recording medium that can extract an attack case example based on an attack technique.

### Means for Solving the Problems

In order to achieve the above-described object, an information processing apparatus according to an example aspect of the present disclosure includes:
a case example extraction unit that extracts, with the use of an analysis result of a cyberattack that includes an attack route and an attack technique corresponding to the attack route, a case example in which the attack technique corresponding to the attack route appears, from a group of case examples of cyberattacks associated with attack techniques.

In order to achieve the above-described object, an information processing method according to an example aspect of the present disclosure includes:
using an analysis result of a cyberattack that includes an attack route and an attack technique corresponding to the attack route, and extracting a case example in which the attack technique corresponding to the attack route appears, from a group of case examples of cyberattacks associated with attack techniques.

In order to achieve the above-described object, a computer readable recording medium according to an example aspect of the present disclosure is a computer readable recording medium that includes recorded thereon a program,
the program including instruction that cause a computer to carry out:
extracting, with the use of an analysis result of a cyberattack that includes an attack route and an attack technique corresponding to the attack route, a case example in which the attack technique corresponding to the attack route appears, from a group of case examples of cyberattacks associated with attack techniques.

### Advantageous Effects of the Invention

As described above, according to the present disclosure, it is possible to extract an attack case example based on an attack technique.

### BRIEF DESCRIPTION OF THE DRAWINGS

FIG. 1 is a configuration diagram illustrating the schematic configuration of the information processing apparatus according to the example embodiment.

FIG. 2 is a configuration diagram illustrating the configuration of the information processing apparatus according to the example embodiment in detail.

FIG. 3 is a diagram illustrating an example of the analysis result that is used in the example embodiment.

FIG. 4 is a diagram illustrating an example of the attack case example data that is used in the example embodiment.

FIG. 5 is a flowchart illustrating operations of the information processing apparatus 10 according to the example embodiment.

FIG. 6 is a block diagram illustrating an example of a computer that realizes the information processing apparatus according to the example embodiment.

### EXAMPLE EMBODIMENT

### Example Embodiment

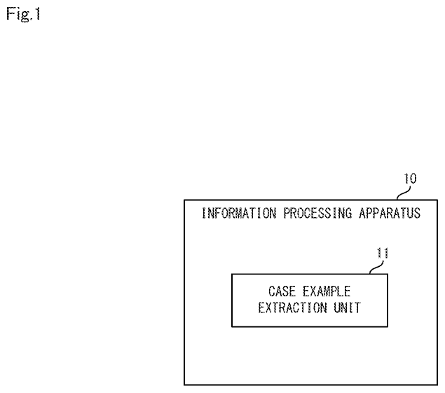

An information processing apparatus according to an example embodiment of the present disclosure will be described below with reference to FIGS. 1 to 6.

### Apparatus Configuration

First, a schematic configuration of the information processing apparatus according to the example embodiment of the present disclosure will be described with reference to FIG. 1. FIG. 1 is a configuration diagram illustrating the schematic configuration of the information processing apparatus according to the example embodiment.

The information processing apparatus 10 according to the example embodiment illustrated in FIG. 1 functions as an information analysis apparatus that extracts a past similar case example based on an analysis result of a cyberattack in a target system.

As illustrated in FIG. 1, the information processing apparatus 10 includes a case example extraction unit 11. The case example extraction unit 11 uses an analysis result of a cyberattack that includes an attack route and an attack technique corresponding to the attack route, and extracts, from a group of case examples of cyberattacks, a case example in which the attack technique included in the analysis result appears. In the group of case examples of cyberattacks, each case example is associated with an attack technique in advance.

As described above, the information processing apparatus 10 can use an attack technique obtained from an analysis result of a cyberattack, and extract a case example in which the attack technique appears. That is to say, with the information processing apparatus 10, it is possible to extract an attack case example based on an attack technique.

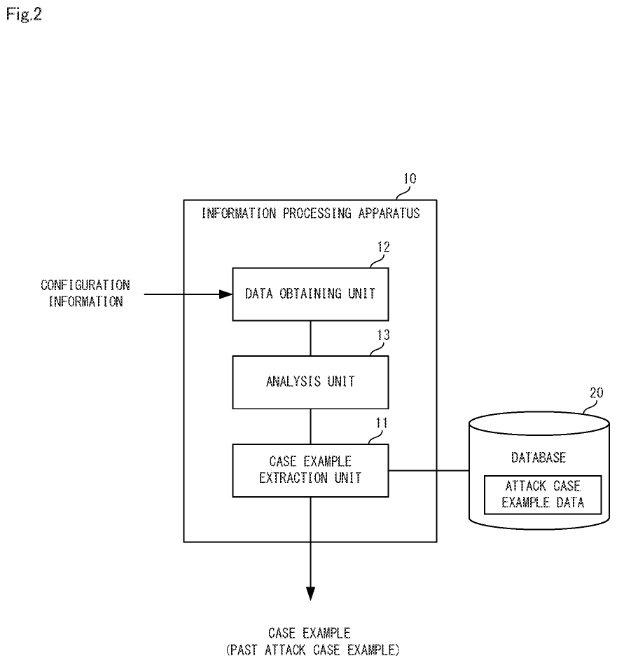

Next, a configuration and functions of the information processing apparatus 10 according to the example embodiment will be described in detail with reference to FIGS. 2 to 4. FIG. 2 is a configuration diagram illustrating the configuration of the information processing apparatus according to the example embodiment in detail.

As illustrated in FIG. 2, the information processing apparatus 10 is connected to a database 20 in a data communicable manner. The database 20 stores a group of case examples of cyberattacks (hereinafter, referred to as “attack case example data”) 21. The database 20 may be constructed in the information processing apparatus 10. In addition, as illustrated in FIG. 2, the information processing apparatus 10 includes a data obtaining unit 12 and an analysis unit 13 in addition to above case example extraction unit 11.

The data obtaining unit 12 obtains configuration information indicating the configuration of a system that is an analysis target (hereinafter, referred to as an “analysis target system”). Examples of the configuration information include information regarding devices that constitute the analysis target system such as the names and version information of OSs (Operating Systems), configuration information of hardware, the names of implemented software, the communication protocol, and the states of ports.

The analysis unit 13 first specifies the devices included in the analysis target system based on the configuration information of the analysis target system, and extracts relevant security information for each of the specified devices, from among security information registered in the devices in advance. Examples of security information include information indicating a vulnerability of each device.

The analysis unit 13 then compares the extracted security information of each device with a preset analysis rule. The analysis rule stipulates an attack technique that may be used for each type of vulnerability. Therefore, the analysis unit 13 detects, in the comparison result, an attack route indicating a flow of an attack that can be executed in the analysis target system and an attack technique that is used for the attack route.

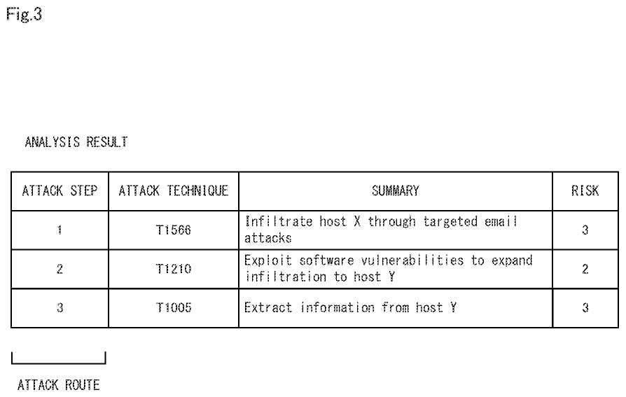

As described above, the analysis unit 13 detects, based on the configuration information of the analysis target system, an attack route of a cyberattack and an attack technique that is used. The analysis unit 13 then outputs the detected attack route and attack technique as an analysis result, as illustrated in FIG. 3. FIG. 3 is a diagram illustrating an example of the analysis result that is used in the example embodiment.

In the example in FIG. 3, the detected attack route is composed of attack steps 1 to 3. In addition, attack techniques that are used for the respective attack steps are specified. In the example in FIG. 3, the expression form of “attack techniques” complies with terms used for MITRE ATT&CK ID (see https://atack.mitre.org). In addition, in the example in FIG. 3, numerals such as “T1550”, “T1566”, and “T1005” are identification numbers for identifying techniques that are used for the attack, and are stipulated in MITRE ATT&CK ID. IDs of CVE (Common Vulnerabilities and Exposures) used for attacks may be used as the expression form of “attack techniques”.

Note that, in the example in FIG. 3, “summary” is for describing the content of each attack step. “Risk” is for evaluation indicating the level of a risk of each attack step, and evaluation is performed by the analysis unit 13.

In addition, a configuration can also be adopted in which the analysis unit 13 specifies the network topology of the analysis target system using the specified devices, overlays the attack route and attack techniques on the specified network topology, and outputs the obtained network topology as an analysis result.

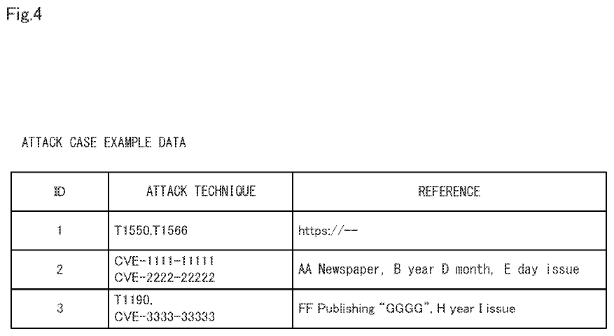

In the example embodiment, the case example extraction unit 11 accesses the database 20, and compares the analysis result output by the analysis unit 13 with the attack case example data 21 stored in the database 20. FIG. 4 is a diagram illustrating an example of the attack case example data that is used in the example embodiment.

As illustrated in FIG. 4, the attack case example data 21 is composed of attack techniques that are used and references of case examples, for the respective IDs (Identifiers) of the case examples. In the example in FIG. 4, “attack technique” is expressed in an expression form that complies with terms used for MITRE ATT&CK ID (see https://atack.mitre.org), or IDs of CVE (Common Vulnerabilities and Exposures). In the field “attack technique”, techniques that are used for the attack are entered.

The case example extraction unit 11 extracts, from the comparison result, a case example that include an attack technique included in the analysis result, and outputs the extracted case example. In addition, the case example extraction unit 11 can extract each case example in which a plurality of attack techniques included in the analysis result appear. In this case, the case example extraction unit 11 can extract case examples in which a plurality of attack techniques included in the analysis result appear, in descending order of the number of such attack techniques.

In addition, assume that a plurality of attack techniques is included in the analysis result, and the analysis result also includes the order in which the attack techniques are used. In this case, the case example extraction unit 11 can extract, from a group of case examples, case examples in descending order of the degree to which the order of the attack techniques matches the order included in the analysis result. Examples of a method for calculating the degree of matching in this case include dividing “the number of attack techniques whose order matches the order included in the analysis result” by “the number of all of the attack techniques included in the analysis result”. Note that the method for calculating the degree of matching is not particularly limited.

In addition, the case example extraction unit 11 can also extract a case example that includes an attack technique designated in advance, preferentially to the other case examples, from case examples that include attack techniques included in the analysis result. In a case where an important attack technique is designated in advance, for example, the case example extraction unit 11 preferentially extracts a case example that includes the important attack technique from the case examples that include attack techniques included in the analysis result.

Designation in the above case may be performed by the administrator of the analysis target system, or may be performed by the analysis unit 13. In the latter case, for example, the analysis unit 13 evaluates the risk for each attack step at the time of analysis processing, as illustrated in FIG. 3, and designates a specific attack technique based on the evaluation result. Note that evaluation is not limited to evaluation of risks, and examples of what is evaluated include the degree of importance of assets, the occurrence frequency of an attack, technical capabilities required for an attack, a threat level, the fullness of countermeasures, a vulnerability level, and a combination thereof.

In addition, the analysis unit 13 can analyze an effect of taking measures against the attack techniques included in the analysis result. In this case, the analysis unit 13 specifies an attack technique for which the effect of taking measures is at a certain level or higher, and designates the specified attack technique in advance.

Furthermore, the case example extraction unit 11 can weight extracted case examples in accordance with the content of the references in FIG. 3. In this case, the case example extraction unit 11 preferentially extracts case examples featured in highly weighted media. Examples of weighting include newspaper being more highly weighted than blogs, economic journals being more highly weighted than sport journals, and the like.

In the above example, for both the analysis unit 13 and the attack case example data 21, an attack technique is expressed in an expression form that complies with terms used for MITRE ATT&CK ID, or IDs of CVE. Note that the present example embodiment is not limited to this mode. In the example embodiment, the expression form of an attack technique may be different between the analysis unit 13 and the attack case example data 21. Note that, in this case, for the case example extraction unit 11, a table that includes an expression form that is used for the analysis unit 13 and an expression form that is used for the attack case example data 21, with the expression forms corresponding to each other, is prepared in advance. The case example extraction unit 11 extracts case examples while referencing the table that includes corresponding expression forms.

### Apparatus Operations

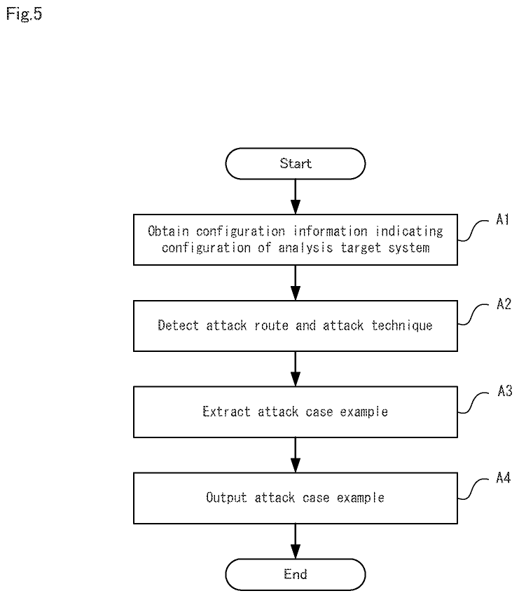

Next, operations of the information processing apparatus 10 according to the example embodiment will be described with reference to FIG. 5. FIG. 5 is a flowchart illustrating operations of the information processing apparatus 10 according to the example embodiment. In the following description, FIGS. 1 to 3 will be referenced as appropriate. In addition, in the example embodiment, an information processing method is performed by causing the information processing apparatus 10 to operate. Thus, the following description of operations of the information processing apparatus replaces description of the information processing method in the example embodiment.

As illustrated in FIG. 4, first, the data obtaining unit 12 obtains configuration information indicating the configuration of the analysis target system (step A1).

Next, the analysis unit 13 detects an attack route in a cyberattack and an attack technique that is used for the attack route, based on the configuration information of the analysis target system obtained in step A1, and outputs the detected attack route and the attack technique as an analysis result (step A2).

Next, the case example extraction unit 11 accesses the database 20, compares the analysis result output in step A2 with the attack case example data 21 stored in the database 20, and extracts, from the comparison result, a case example that includes the attack technique included in the analysis result (step A3).

Thereafter, the case example extraction unit 11 outputs the case example extracted in step A3 (step A4). The case example that has been output is a past attack case example in which the attack routes estimated in step A2 were used.

### EFFECTS OF EXAMPLE EMBODIMENT

As descried above, in the example embodiment, the information processing apparatus 10 can extract, using attack techniques obtained from an analysis result of a cyberattack, a case example in which the attack techniques appear. That is to say, with the information processing apparatus 10, it is possible to extract an attack case example based on attack techniques.

In addition, the information processing apparatus 10 can specify an attack route estimated in an analysis target system and attack techniques corresponding to the attack route, based on configuration information of the analysis target system. Thus, in the example embodiment, if only the configuration information of the analysis target system is prepared, it is possible to specify a past attack case example in which the attack route estimated in the target system was used.

### Modified Example

In the above-described example in FIG. 2, the information processing apparatus 10 is provided with the analysis unit 13, but, in the example embodiment, a mode may also be adopted in which the information processing apparatus 10 is not provided with the analysis unit 13. In this case, an analysis result is input to the information processing apparatus 10 by the administrator of the analysis target system, or the like.

In addition, in the example embodiment, the attack route may be obtained by analyzing a system log at the time of the occurrence of an incident, instead of being obtained through analysis. Furthermore, the attack route may be an attack route for an exercise of an incident response.

### [Program]

A program in the example embodiment is any program that causes a computer to execute steps A1 to A4 illustrated in FIG. 5. The information processing apparatus and the information processing method in the present example embodiment can be realized, by installing the program in the computer and executing the installed program. In this case, the processor of the computer functions as the case example extraction unit 11, the data obtaining unit 12, and the analysis unit 13 to perform processing. The computer may be a general-purpose PC, a smartphone, or a tablet terminal device.

The program in the example embodiment may be executed by a computer system that is constructed of a plurality of computers. In this case, each computer may function as any of the case example extraction unit 11, the data obtaining unit 12, and the analysis unit 13.

[Physical configuration]

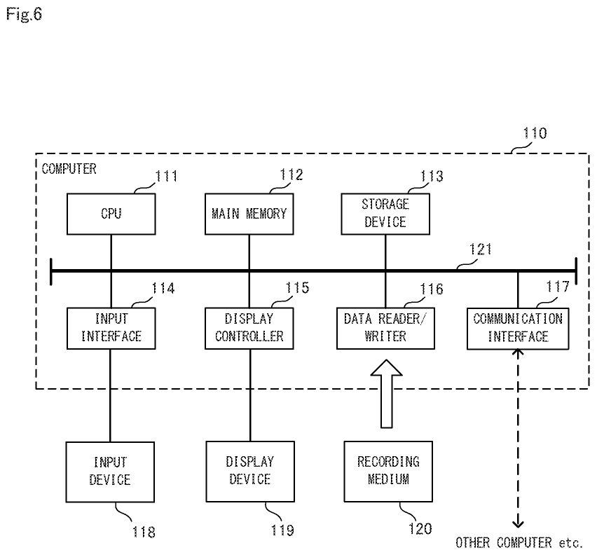

Using FIG. 6, the following describes a computer that realizes the information processing apparatus 10 by executing the program according to the example embodiment. FIG. 6 is a block diagram illustrating an example of a computer that realizes the information processing apparatus 10 according to the example embodiment.

As illustrated in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital): a magnetic recording medium, such as a flexible disk; and an optical recording medium, such as a CD-ROM (Compact Disk Read Only Memory).

Note that the information processing apparatus 10 according to the example embodiment can also be realized by using items of hardware correspond to the components rather than the computer in which the program is installed. Furthermore, a part of the information processing apparatus 10 may be realized by the program, and the remaining part of the information processing apparatus 10 may be realized by hardware.

A part or an entirety of the above-described example embodiment can be represented by (Supplementary Note 1) to (Supplementary Note 18) described below but is not limited to the description below:

### (Supplementary Note 1)

An information processing apparatus includes:
a case example extraction unit that extracts, with the use of an analysis result of a cyberattack that includes an attack route and an attack technique corresponding to the attack route, a case example in which the attack technique corresponding to the attack route appears, from a group of case examples of cyberattacks associated with attack techniques.

### (Supplementary Note 2)

The information processing apparatus according to supplementary note 1,
wherein the case example extraction unit extracts, as the case example, a case example in which a plurality of attack techniques corresponding to the attack route appear.

### (Supplementary Note 3)

The information processing apparatus according to supplementary note 2,
wherein the case example extraction unit extracts case examples in descending order of the number of attack techniques corresponding to the attack route, from case examples in which a plurality of attack techniques corresponding to the attack route appear.

### (Supplementary Note 4)

The information processing apparatus according to supplementary note 2,
wherein, when the analysis result includes a plurality of attack techniques corresponding to the attack route, and an order in which the attack techniques are used, the case example extraction unit extracts, from the group of case examples, case examples in descending order of the degree to which an order of attack techniques corresponding to the attack route matches the order included in the analysis result.

### (Supplementary Note 5)

The information processing apparatus according to supplementary note 1,
wherein the case example extraction unit extracts a case example in which an attack technique designated in advance appears, preferentially to another case example, from case examples in which an attack technique corresponding to the attack route appears.

### (Supplementary Note 6)

The information processing apparatus according to any one of supplementary notes 1 to 5, further comprising:
an analysis unit that detects an attack route in a cyberattack and an attack technique that is used for the attack route, based on configuration information indicating a configuration of a system, and outputs the detected attack route and attack technique as the analysis result.

### (Supplementary Note 7)

An information processing method comprising:
using an analysis result of a cyberattack that includes an attack route and an attack technique corresponding to the attack route, and extracting a case example in which the attack technique corresponding to the attack route appears, from a group of case examples of cyberattacks associated with attack techniques.

### (Supplementary Note 8)

The information processing method according to supplementary note 7,
wherein, in the extraction of a case example, a case example in which a plurality of attack techniques corresponding to the attack route appear is extracted as the case example.

### (Supplementary Note 9)

The information processing method according to according to supplementary note 8,
wherein, in the extraction of a case example, case examples are extracted in descending order of the number of attack techniques corresponding to the attack route, from case examples in which a plurality of attack techniques corresponding to the attack route appear.

The information processing method according to according to supplementary note 8,
wherein, in the extraction of a case example, case examples are extracted in descending order of the number of attack techniques corresponding to the attack route, from case examples in which a plurality of attack techniques corresponding to the attack route appear.

### (Supplementary Note 10)

The information processing method according to supplementary note 8,
wherein, when the analysis result includes a plurality of attack techniques corresponding to the attack route, and an order in which the attack techniques are used,
in the extraction of a case example, from the group of case examples, case examples are extracted in descending order of the degree to which an order of attack techniques corresponding to the attack route matches the order included in the analysis result.

### (Supplementary Note 11)

The information processing method according to supplementary note 7,
wherein, in the extraction of a case example, a case example in which an attack technique designated in advance appears is extracted preferentially to another case example, from case examples in which an attack technique corresponding to the attack route appears.

### (Supplementary Note 12)

The information processing method according to any one of supplementary notes 7 to 11, further comprising:
detecting an attack route in a cyberattack and an attack technique that is used for the attack route, based on configuration information indicating a configuration of a system, and outputting the detected attack route and attack technique as the analysis result.

### (Supplementary Note 13)

A computer-readable recording medium that includes a program recorded thereon, the program including instructions that cause a computer to:
extracting, with the use of an analysis result of a cyberattack that includes an attack route and an attack technique corresponding to the attack route, a case example in which the attack technique corresponding to the attack route appears, from a group of case examples of cyberattacks associated with attack techniques.

### (Supplementary Notel 4)

The computer-readable recording medium according to supplementary note 13,
wherein, in the extraction of a case example, a case example in which a plurality of attack techniques corresponding to the attack route appear is extracted as the case example.

### (Supplementary Note 15)

The computer-readable recording medium according to supplementary note 14,
wherein, in the extraction of a case example, case examples are extracted in descending order of the number of attack techniques corresponding to the attack route, from case examples in which a plurality of attack techniques corresponding to the attack route appear.

### (Supplementary Note 16)

The computer-readable recording medium according to supplementary note 14,
wherein, when the analysis result includes a plurality of attack techniques corresponding to the attack route, and an order in which the attack techniques are used,
in the extraction of a case example, from the group of case examples, case examples are extracted in descending order of the degree to which an order of attack techniques corresponding to the attack route matches the order included in the analysis result.

### (Supplementary Note 17)

The computer-readable recording medium according to supplementary note 13,
wherein, in the extraction of a case example, a case example in which an attack technique designated in advance appears is extracted preferentially to another case example, from case examples in which an attack technique corresponding to the attack route appears.

### (Supplementary Note 18)

The computer-readable recording medium according to any one of supplementary notes 13 to 17,
wherein the program including instructions that cause a computer to:
detect an attack route in a cyberattack and an attack technique that is used for the attack route, based on configuration information indicating a configuration of a system, and output the detected attack route and attack technique as the analysis result.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present disclosure, it is possible to extract an attack case example based on an attack technique. The present disclosure is useful for various systems requiring analysis of cyberattacks.

### REFERENCE SIGNS LIST

10 Information processing apparatus
11 Case example extraction unit
12 Data obtaining unit
13 Analysis unit
20 Database
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
extract, with the use of an analysis result of a cyberattack that includes an attack route and an attack technique corresponding to the attack route, a case example in which the attack technique corresponding to the attack route appears, from a group of case examples of cyberattacks associated with attack techniques.

2. The information processing apparatus according to claim 1,
wherein the one or more processors further extracts, as the case example, a case example in which a plurality of attack techniques corresponding to the attack route appear.

3. The information processing apparatus according to claim 2,
wherein the one or more processors further extracts case examples in descending order of the number of attack techniques corresponding to the attack route, from case examples in which a plurality of attack techniques corresponding to the attack route appear.

4. The information processing apparatus according to claim 2,
wherein, when the analysis result includes a plurality of attack techniques corresponding to the attack route, and an order in which the attack techniques are used,
the one or more processors further extracts, from the group of case examples, case examples in descending order of the degree to which an order of attack techniques corresponding to the attack route matches the order included in the analysis result.

5. The information processing apparatus according to claim 1,
wherein the one or more processors further extracts a case example in which an attack technique designated in advance appears, preferentially to another case example, from case examples in which an attack technique corresponding to the attack route appears.

6. The information processing apparatus according to claim 1,
wherein the one or more processors further detects:
an attack route in a cyberattack and an attack technique that is used for the attack route, based on configuration information indicating a configuration of a system, and outputs the detected attack route and attack technique as the analysis result.

7. An information processing method comprising:
using an analysis result of a cyberattack that includes an attack route and an attack technique corresponding to the attack route, and extracting a case example in which the attack technique corresponding to the attack route appears, from a group of case examples of cyberattacks associated with attack techniques.

8. The information processing method according to claim 7,
wherein, in the extraction of a case example, a case example in which a plurality of attack techniques corresponding to the attack route appear is extracted as the case example.

9. The information processing method according to according to claim 8,
wherein, in the extraction of a case example, case examples are extracted in descending order of the number of attack techniques corresponding to the attack route, from case examples in which a plurality of attack techniques corresponding to the attack route appear.

10. The information processing method according to claim 8,
wherein, when the analysis result includes a plurality of attack techniques corresponding to the attack route, and an order in which the attack techniques are used,
in the extraction of a case example, from the group of case examples, case examples are extracted in descending order of the degree to which an order of attack techniques corresponding to the attack route matches the order included in the analysis result.

11. The information processing method according to claim 7,
wherein, in the extraction of a case example, a case example in which an attack technique designated in advance appears is extracted preferentially to another case example, from case examples in which an attack technique corresponding to the attack route appears.

12. The information processing method according to claim 7, further comprising:
detecting an attack route in a cyberattack and an attack technique that is used for the attack route, based on configuration information indicating a configuration of a system, and outputting the detected attack route and attack technique as the analysis result.

13. A non-transitory computer-readable recording medium that includes a program recorded thereon, the program including instructions that cause a computer to:
extracting, with the use of an analysis result of a cyberattack that includes an attack route and an attack technique corresponding to the attack route, a case example in which the attack technique corresponding to the attack route appears, from a group of case examples of cyberattacks associated with attack techniques.

14. The non-transitory computer-readable recording medium according to claim 13,
wherein, in the extraction of a case example, a case example in which a plurality of attack techniques corresponding to the attack route appear is extracted as the case example.

15. The non-transitory computer-readable recording medium according to claim 14,
wherein, in the extraction of a case example, case examples are extracted in descending order of the number of attack techniques corresponding to the attack route, from case examples in which a plurality of attack techniques corresponding to the attack route appear.

16. The non-transitory computer-readable recording medium according to claim 14,
wherein, when the analysis result includes a plurality of attack techniques corresponding to the attack route, and an order in which the attack techniques are used,
in the extraction of a case example, from the group of case examples, case examples are extracted in descending order of the degree to which an order of attack techniques corresponding to the attack route matches the order included in the analysis result.

17. The non-transitory computer-readable recording medium according to claim 13,
wherein, in the extraction of a case example, a case example in which an attack technique designated in advance appears is extracted preferentially to another case example, from case examples in which an attack technique corresponding to the attack route appears.

18. The non-transitory computer-readable recording medium according to claim 13,
wherein the program including instructions that cause a computer to:
detect an attack route in a cyberattack and an attack technique that is used for the attack route, based on configuration information indicating a configuration of a system, and output the detected attack route and attack technique as the analysis result.
